(19) United States
(12) Patent Application Publication
(10) Pub. No.: US 2020/0288545 A1
(43) Pub. Date: Sep. 10, 2020

(54) PROCESS AND SYSTEM FOR MICROWAVE COOKING FOOD PRODUCTS WITH HUMIDIFIED AIR CONTROL

(71) Applicant: Sugar Creek Packing Co., Washington Court House, OH (US)

(72) Inventors: Patrick N. ANTHONY, Kansas City, KS (US); Robert E. HANSON, Hudson, WI (US); Dennis Michael MANGER, Union, OH (US); Christopher Neil BLACKMON, Pittsburg, KS (US)

(21) Appl. No.: 16/804,274

(22) Filed: Feb. 28, 2020

Related U.S. Application Data
(60) Provisional application No. 62/815,127, filed on Mar. 7, 2019.

(51) Int. Cl. H05B 6/64; A23L 5/10; H05B 6/68

(52) U.S. Cl. CPC H05B 6/6458; A23L 5/15; A23V 2002/00; H05B 6/687; A23L 5/13

(57) ABSTRACT

A process and system for microwave cooking food products with humidified air control. In an exemplary embodiment, the system includes a microwave cooking enclosure; a source of microwave energy that transmits microwave radiation into an interior of the enclosure; a microwave-shielded sensor positioned within the interior of the enclosure; a nozzle connected to provide steam and/or water mist to the enclosure to form humidified air therein; and a control connected to receive a signal from the microwave-shielded sensor indicative of the wet-bulb temperature within the enclosure and in response modulate a flow of steam and/or water mist into the enclosure to maintain the wet-bulb temperature of the humidified air therein at or above a predetermined value and to actuate the source of microwave energy to transmit the microwave radiation into the interior of the enclosure, whereby the microwave radiation and the humidified air simultaneously cook the food products and kill microorganisms in the interior of the microwave cooking enclosure and on the surface of and within the food products.

### TECHNICAL FIELD

The present disclosure relates to processes and systems for cooking food products using microwave radiation, and more particularly, to processes and systems for cooking food by microwave radiation in which the relative humidity in the cooking chamber is controlled during cooking.

### BACKGROUND

Microwave ovens are commonly used to cook food products, both commercially and domestically. Cooking food products using microwaves, for example microwave cooking of bacon slices, particularly when performed commercially on a high-volume basis, often results in uneven tenderness in the cooked food product in which a significant percentage of slices are undesirably chewy and tough. Microwave cooking of bacon slices also frequently produces bacon slices in which some bacon is not fully cooked when it is discharged from the microwave oven.

High volume commercial microwave cooking systems typically utilize conveyors, such as belt conveyors, that transport the food product to be cooked through cooking enclosures such as microwave cavities in which the food product to be cooked is exposed to microwave radiation generated by a magnetron and transmitted to the cooking enclosure through a waveguide. In order to cook a food product, for example bacon slices, to a higher temperature, it is often necessary to reduce the conveyor speed to increase residence time of the food product in the cooking enclosure or microwave enclosure.

Starting and stopping the food product conveyor through the cooking enclosure in such commercial systems also can result in an undercooked or overcooked food product, such as bacon slices, due to stopping and starting of the magnetrons. Accordingly, it is desirable to minimize starting and stopping the food product conveyor. Cooking cavities typically include manually adjustable exhaust dampers that are adjustable to remove excess moisture from the microwave cavities created by the food being cooked. However, there is no internal measurement of the dry-bulb or wet-bulb temperatures in such conventional cooking enclosures utilizing microwave cooking systems.

Reducing the speed of the food product conveyor through a commercial microwave cooking system reduces throughput and cooks the food product higher temperatures, which adversely affects yields and can overcook portions of the food product. Starts and stops of the food product conveyor are inherent in high-volume microwave cooking systems and therefore are unavoidable, resulting in overcooking, undercooking, variable texture, and variable yields for some percentage of the food product. Manual damper controls are not effective in responding quickly to temperature changes in the microwave enclosure and do not automatically compensate for variable incoming product loads.

Conventional continuous microwave processes in which the moisture content or relative humidity of the air in a microwave cooking enclosure is not controlled result in significant percentages of food product, such as bacon slices, that are tough and/or undercooked. Maintaining sufficiently moist air in the microwave enclosure increases the lethality of the microwave cooking process at a given temperature because non-desiccated bacteria are more vulnerable to being killed than desiccated bacteria at a given temperature.

Existing forms of moisture control in microwave ovens do not measure the wet-bulb temperature directly, and do not inject moisture into the microwave cooking enclosure to control or modulate the wet-bulb temperature, and thus the relative humidity, in the enclosure. Existing microwave cooking systems typically have only a manually operated damper on the cooking enclosure exhaust stack, but do not have any way to automatically measure or control the wet-bulb temperature, dew-point, or relative humidity of the air in the microwave cooking enclosure.

Accordingly, there is a need for a microwave cooking system and process having active measurement and control of the wet-bulb temperature in the microwave cooking enclosure. There also is a need for a microwave cooking system and process that allows precise control of the tenderization of the microwaved food item and the requisite lethality of the cooking process.

### SUMMARY

In an embodiment, the disclosed process and system utilize microwave cooking during which the wet-bulb temperature in the microwave cooking enclosure is maintained by a closed-loop control to modulate the wet bulb temperature in a microwave cooking enclosure both to optimally tenderize and fully cook food products and to provide requisite lethality to microorganisms on and in the food products being cooked and the conveyor equipment that transports the food products through the microwave cooking enclosure. For example, the process and system tenderize and fully cook bacon slices when discharged from the system. The disclosed process and system also assure that no microorganisms, such as bacteria, survive on the belt and supporting structure of the microwave conveyor, including in harborage areas that otherwise would not be heated to lethal temperatures using microwaves alone.

In an embodiment, the disclosed process measures and actively controls the moisture level in a continuous series of microwave ovens, such as used for microwave cooking bacon slices. Moisture is injected into the microwave oven in the form of steam, in embodiments saturated steam, or a water mist to control the wet-bulb temperatures in the microwave ovens at a level that will assure the destruction of microorganisms such as pathogenic bacteria on the slices and on the belt. Also, the wet-bulb temperature in the microwave cooking enclosures is modulated to maintain a predetermined minimum temperature that tenderizes the bacon slices by degrading the collagen-laden connective tissue that causes toughness in bacon.

In an exemplary embodiment, a system for microwave cooking food products with humidified air control includes a microwave cooking enclosure, a source of microwave energy connected to transmit microwave radiation into an interior of the microwave cooking enclosure, a microwave-shielded sensor positioned within the interior of the microwave cooking enclosure, a steam nozzle connected to provide steam to the interior of the microwave cooking enclosure to make humidified air therein, and a control. The control is connected to receive a signal from the microwave-shielded sensor indicative of a wet-bulb temperature within the interior of the microwave cooking enclosure and in response modulate a flow of steam into the interior of the microwave cooking enclosure to maintain a wet-bulb temperature of the humidified air therein at or above a predetermined value and to actuate the source of microwave energy to transmit the microwave radiation into the interior of the microwave cooking enclosure, whereby the microwave radiation and the humidified air simultaneously cook the food products in the interior of the microwave cooking enclosure and kill microorganisms in the interior of the microwave cooking enclosure and on a the surface of and within the food products.

In embodiments, the system uses microwave-shielded dry- and wet-bulb sensors located directly inside the microwave cooking enclosure. The microwave shields enclose the dry- and wet-bulb sensors and act as Faraday cages having openings sized to allow ingress of the moisture-laden air in the enclosure so that the sensors can measure the wet bulb and dry bulb air temperatures inside the enclosure, but block microwaves from entering the cages to protect the temperature sensors from damage from microwave radiation and to prevent arcing in the microwave cooking enclosure.

The wet-bulb sensor measures the temperature that moisture is evaporating inside the enclosure. In embodiments, the wet bulb sensor uses a nozzle that mists water onto a temperature sensor, so that the localized moisture evaporation within a cloud of water vapor around the sensor cools the sensor down to the wet-bulb temperature. In other embodiments, the wet-bulb sensor uses a conventional design in which an end of a sock made of moisture-wicking material is inserted in a pan of water and an opposite end is draped over the wet bulb sensor.

In embodiments, the wet-bulb temperature sensor, and optionally the dry-bulb temperature sensor, are used as the input or sensing element as part of a feedback control loop in which a control modulates a valve to regulate injection of steam or atomized water into the microwave cooking enclosure to maintain a predetermined wet-bulb temperature. Optionally, the closed loop system is connected so that the control modulates an exhaust damper that regulates the exhaust of moisture-laden air from the microwave cooking enclosure. In embodiments, this feedback control loop system is configured to automatically control the wet-bulb temperature inside the enclosure using the steam valve to increase or decrease the actual wet-bulb temperature to maintain a pre-programmed set-point and/or temperature range.

In another exemplary embodiment, a system for microwave cooking food products with humidified air control includes a microwave cooking unit, the microwave cooking unit including a microwave cooking enclosure, a source of microwave energy connected to transmit microwave radiation into an interior of the microwave cooking enclosure, a microwave-shielded sensor positioned within the interior of the microwave cooking enclosure that detects one or more of a wet-bulb temperature, dew point temperature, and relative humidity within the microwave cooking enclosure, a steam nozzle connected to provide steam to the interior of the microwave cooking enclosure to make humidified air therein, and an exhaust damper connected to the interior of the microwave cooking enclosure to exhaust the humidified air from the interior of the microwave cooking chamber. The system further includes a conveyor that conveys food products into and out of the interior of the microwave cooking enclosure and a control connected to receive a signal from the microwave-shielded sensor indicative of the one or more of the wet-bulb temperature, the dew point temperature, and the relative humidity within the interior of the microwave cooking enclosure and in response modulate a flow of steam from the steam nozzle into the interior of the microwave cooking enclosure and/or modulate the exhaust damper to maintain the wet-bulb temperature within the interior of the microwave cooking chamber at or above a predetermined value and simultaneously actuate the source of microwave energy to transmit the microwave radiation into the interior of the microwave cooking enclosure, whereby the microwave radiation and the humidified air combine to cook the food products on the conveyor in the interior of the microwave cooking enclosure and kill microorganisms on the outer surface of and within the food products, on the conveyor in the interior of the microwave cooking enclosure, and on the interior of the microwave cooking enclosure.

Meat collagen degrades within a temperature range of approximately 158-210° F., and preferably 176-194° F. As such, meats that contain high amounts of collagen are much more tender when cooked to temperatures of at least 158° F., preferably 176° F. or higher, to degrade the collagen to a more tender state. By way of example, bacon slices are high in collagen, and therefore if bacon slices are cooked to a temperature of 176° F. or higher, the slices are much more tender than if the slices are cooked to lower temperatures. In a conventional microwave oven in which moisture content of the air in the microwave enclosure is not controlled, the final bacon slice temperatures are highly variable. Any slices that are cooked to temperatures of less than 176° F. tend to be much tougher than slices that are cooked to 176° F. or higher, and hence the variable slice temperatures from a conventional microwave oven will result in slices that have varied degrees of tenderness/toughness.

Desiccated bacteria are much harder to kill than non-desiccated bacteria. In a conventional microwave oven without moisture control, the bacon slices may be dehydrated during cooking so that the bacteria are desiccated before lethal temperatures are achieved, and thus all the desiccated bacteria may not be destroyed during cooking.

In yet another exemplary embodiment, a process for microwave cooking food products with humidified air control includes placing food products into an interior of a microwave cooking enclosure of a cooking unit; transmitting microwave radiation from a source of microwave energy into the interior of the microwave cooking enclosure to cook the food item; generating a signal from a microwave-shielded sensor positioned within the interior of the microwave cooking enclosure indicative of a wet bulb temperature within the interior of the microwave cooking enclosure; and providing a flow of steam to the interior of the microwave cooking enclosure to form humidified air therein. The process further includes maintaining the wet-bulb temperature within the interior of the microwave cooking enclosure at or above a predetermined value by a control receiving a signal from the microwave-shielded sensor indicative of the wet-bulb temperature within the interior of the microwave cooking enclosure and in response modulating the flow of steam into the interior of the microwave cooking enclosure. Microwave radiation is transmitted into the interior of the microwave cooking enclosure simultaneously with maintaining the wet-bulb temperature to cook the food products in the interior of the microwave cooking enclosure, and kill microorganisms with a combination of the microwave radiation and the steam in the interior of the microwave cooking enclosure and on the outer surface of and within the food products therein.

In still another exemplary embodiment, a process for microwave cooking food products with humidified air control includes placing food products into an interior of a microwave cooking enclosure of a cooking unit; transmitting microwave radiation from a source of microwave energy into the interior of the microwave cooking enclosure to cook the food products; providing a flow of steam and/or water spray to the interior of the microwave cooking enclosure to form humidified air therein; maintaining a wet-bulb temperature of the humidified air within the interior of the microwave cooking enclosure at or above a predetermined value; and simultaneously with maintaining the relative humidity, transmitting the microwave radiation into the interior of the microwave cooking enclosure, the microwave radiation and the humidified air combining to cook the food products in the interior of the microwave cooking enclosure and kill microorganisms in the interior of the microwave cooking enclosure and on an outer surface of and within the food products.

With the disclosed process and system, the wet-bulb temperature in the microwave cooking enclosure is modulated by the closed-loop system to be maintained at a predetermined temperature and/or temperature range, for example 176° F. or higher for bacon slices, to ensure that all slices are treated with a tenderizing cooking process that sufficiently degrades the collagen, thus tenderizing all of the bacon slices to a uniform state of tenderized bacon. The moist heat at a lethal temperature assures that all microwaved food, for example bacon slices, is heated to a lethal wet-bulb temperature, for example 160° F., that assures that any pathogenic bacteria are destroyed in a hydrated state before being desiccated.

Other objects and advantages of the disclosed process and system for microwave cooking food products with humidified air control will be apparent from the following description, the accompanying drawings and the appended claims.

### BRIEF DESCRIPTION OF THE DRAWINGS

FIG. 1 is a schematic, perspective view of an exemplary embodiment of the disclosed system for microwave cooking food products with humidified air control;

FIG. 2 is a schematic side elevation of the system of FIG. 1, showing two representative microwave cooking units of the four units depicted in FIG. 1;

FIGS. 3A, 3B, 3C, and 3D are top plan, perspective, front elevation, and side elevation, respectively, of an exemplary embodiment of a wet bulb temperature sensor unit of the embodiment of FIG. 1;

FIGS. 4A, 4B, and 4C are side elevation, perspective, and end views, respectively, of the microwave shield of the wet-bulb temperature sensor unit of FIGS. 3A-3D;

FIGS. 5A, 5B, and 5C are top plan, front elevation, and side elevation, respectively, of the top plate of the wet-bulb temperature sensor unit of FIGS. 3A-3D;

FIGS. 6A, 6B, 6C, and 6D are top plan, perspective, front elevation, and side elevation, respectively, of an exemplary embodiment of a dry-bulb temperature sensor unit of the embodiment of FIG. 1;

FIGS. 7A, 7B, and 7C are side elevation, perspective, and end views, respectively, of the microwave shield of the dry-bulb temperature sensor unit of FIGS. 6A-6D; and

FIGS. 8A, 8B, and 8C are top plan, front elevation, and side elevation, respectively, of the top plate of the dry-bulb temperature sensor unit of FIGS. 6A-6D.

### DETAILED DESCRIPTION

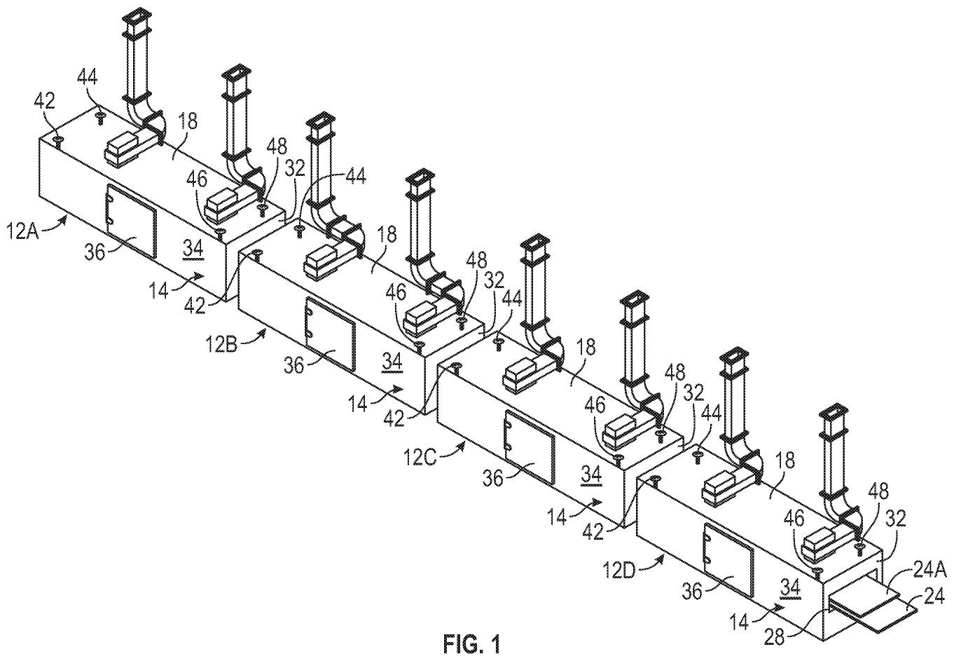

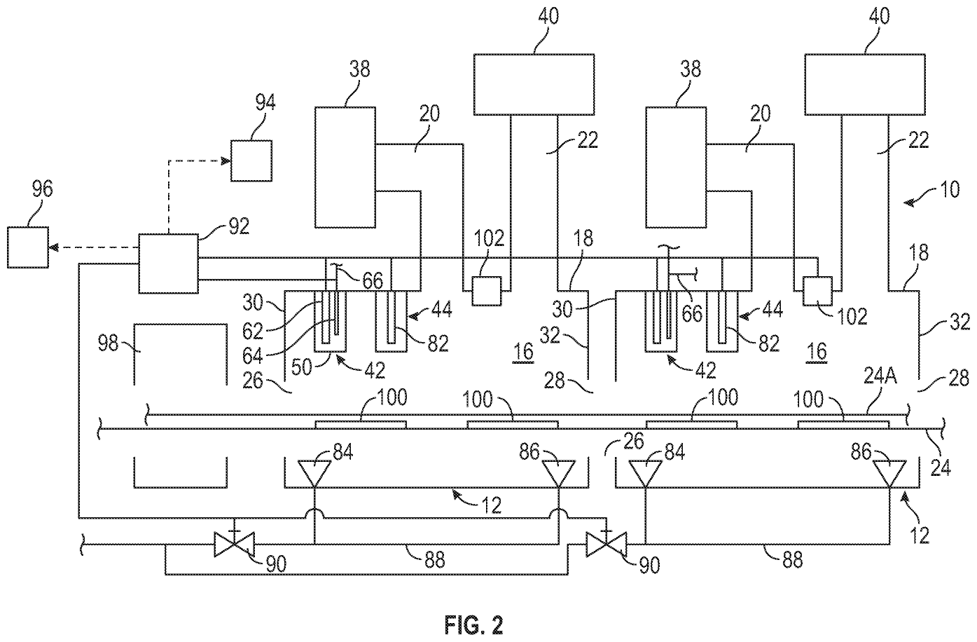

As shown in FIGS. 1 and 2, an exemplary embodiment of the disclosed system for microwave cooking food products with humidified air control, generally designated 10, includes discrete microwave cooking units 12A, 12B, 12C, and 12D. In other embodiments, the system 10 includes more or fewer cooking units 12, and in still other embodiments a single cooking unit 12 is used. In embodiments, the cooking units 12A-12D each include a housing 14 that encloses and defines a microwave cooking enclosure 16, where food products are cooked. In embodiments, one or more of the housings 14 has more than one microwave cooking enclosure 16. The housings 14 each include a top wall 18 that is attached to front and rear wave guides 20, 22, respectively, that open into and communicate with the microwave cooking enclosures 16. In other embodiments, a single waveguide 20 is used for each microwave cooking enclosure 16, or more than two waveguides are used for each microwave cooking enclosure. In an embodiment, the housing 14 includes a side wall 34 with an access door 36.

The cooking units 12A-12D are connected in series by a conveyor, which in embodiments is an endless belt conveyor 24, that passes through the cooking enclosures 16 of the cooking units and through entrance and exit openings 26, 28 in the front and rear side walls 30, 32 respectively of each cooking enclosure. In embodiments, the conveyor takes the form of a conveyor belt in a single lane, or conveyor belts in 2 lanes, 3 lanes, 4 lanes, or more, and the lanes are arranged horizontally in parallel and/or are stacked vertically. Conveyor 24 supports food products 100 to be cooked in the microwave cooking enclosures 16. Optionally, a second belt conveyor 24A, spaced vertically above the belt conveyor 24, passes through the cooking enclosures 16 such that the food products 100 are held between the belt conveyors 24, 24A. In embodiments, the conveyors 24, 24A include belts made of polypropylene to avoid interference with the microwave radiation within the microwave cooking enclosures 16. In embodiments, any support structure within the cooking enclosures 16 also is made of polypropylene, or other material that does not interfere with microwave radiation.

The system 10 and process are ideally suited for such food products 100 as bacon strips, and in other embodiments, the food products take the form of various forms of animal protein, such as beef, pork, lamb, poultry such as chicken, duck, and turkey, and fish. For food products 100 in the form of strips, such as bacon strips, the strips are held between the two belt conveyers 24, 24A.

As shown in FIG. 2, in an embodiment the system 10 includes a source of microwave radiation, which may take the form of front and/or rear magnetrons 38, 40, respectively, that are connected to the waveguides 20, 22 of the housing 14 of each cooking unit 12, respectively, to transmit microwave radiation through the waveguides 20, 22 into the microwave cooking enclosures 16. In embodiments, each of the cooking units 12A-12D includes an exhaust damper 102 that is selectively modulated to control air flow from the microwave cooking enclosure 16 to the ambient. In embodiments, the exhaust damper 102 includes a duct communicating with the microwave cooking enclosure 16, adjustable louvers, which in embodiments are be gravity controlled or remotely adjustable by control 92, and/or an exhaust fan, such as a variable speed exhaust fan, which in embodiments is actuated by control 92, and/or is thermostatically controlled. The exhaust damper 102 controls the flow of humid air exhausted from the microwave cooking enclosure 16. In other embodiments, each of the cooking units 12A-12D includes two or more exhaust dampers 102 that are independently controlled.

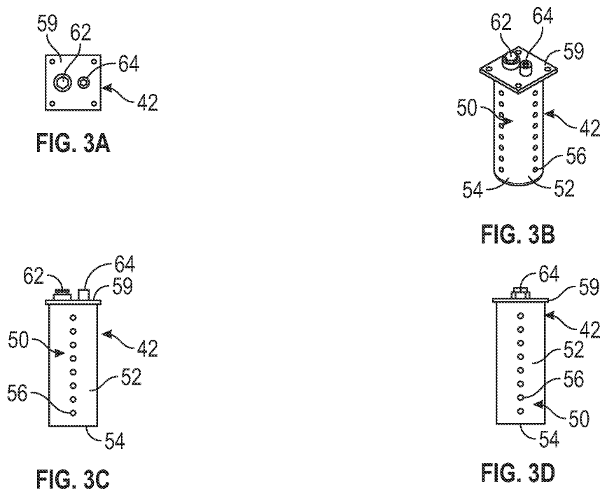

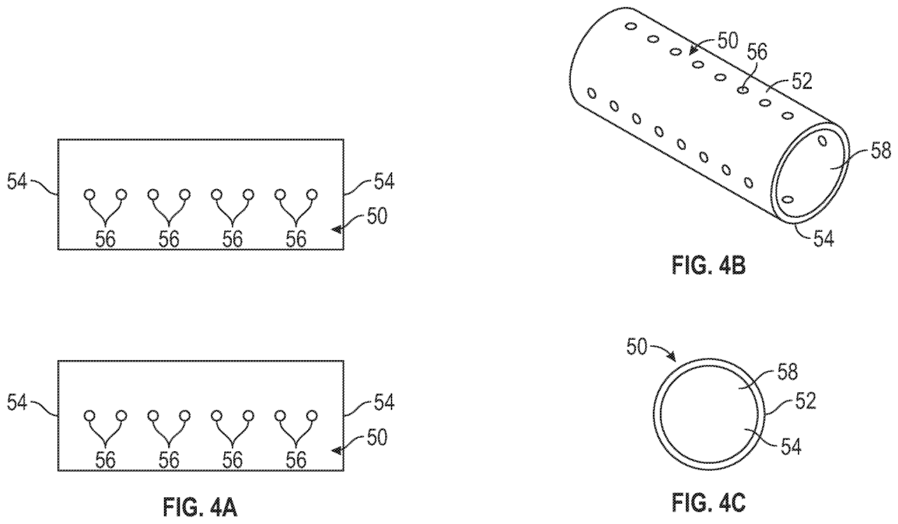

In an exemplary embodiment, each cooking unit 12A-12D includes a wet-bulb temperature sensor unit 42 and optionally a dry-bulb temperature sensor unit 44. As shown in FIG. 1, optionally, one or more of the cooking units 12A-12D includes a second wet-bulb temperature sensor unit 46 and a second dry-bulb temperature sensor unit 48. As also shown in FIGS. 3A, 3B, 3C, and 3D, and FIGS. 4A, 4B, and 4C, each wet-bulb temperature sensor unit 42 includes a microwave shield 50. In embodiments, the microwave shield 50 is a cylindrical tube 52 with open ends 54 and a plurality of openings 56 along its length. In embodiments, the openings 56 are arranged in rectilinear rows along the length of the tube 52. In other embodiments, the openings 56 are arranged randomly or in other patterns, and there may be more or fewer than illustrated in the figures. In embodiments, the openings 56 are circular to eliminate microwave arcing points but may take different shapes. In still other embodiments, the shield 50 takes the form of a metal mesh screen in which the openings 56 are in the form of screen openings. The openings 56 of these embodiments are sized to block microwave radiation from entering the interior 58 of the shield. In embodiments, the shield is made of stainless steel, but other corrosion-resistant conductive materials may be used.

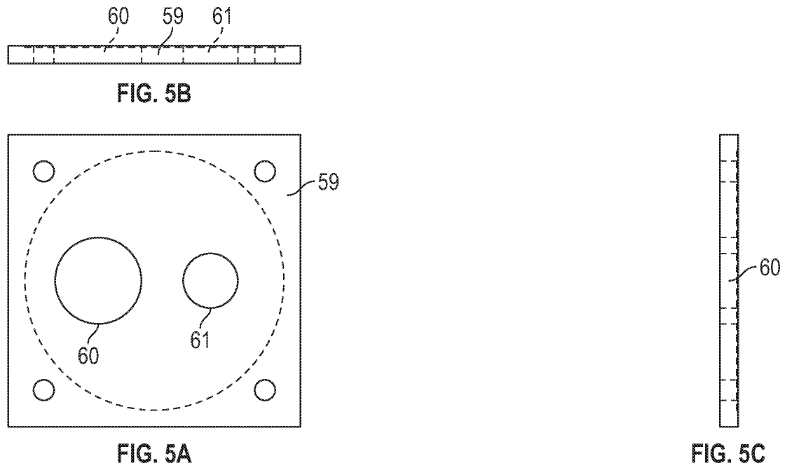

Each wet-bulb temperature sensor unit 42 includes a top plate 59 (see also FIGS. 5A, 5B, and 5C) that is attached to and covers an upper open end 54 of the tube 52. The top plate 59 is attached to, or forms a part of, the top wall 18 of the housing 14 (see FIGS. 1 and 2). In embodiments, the top plate 59 includes openings 60, 61 that receive and support a wet-bulb temperature probe or sensor 62 and a misting nozzle 64, respectively, (FIG. 2 and FIGS. 3A-3D) connected to a source of water 66 (FIG. 2). The wet-bulb temperature sensor unit 42 is mounted on the top wall 18 of the housing 14 such that the microwave shield 50, and thus the temperature sensor 62 and misting nozzle 64, extend into the microwave cooking enclosure 16. In embodiments, the shield 50 has a length that extends beyond the lengths of the wet-bulb temperature sensor 62 and misting nozzle 64 sufficiently to prevent microwaves from entering the lower or bottom open end 54 and contacting the probe and nozzle. In other embodiments, the lower or bottom open end 54 is closed or sealed with a metal plate (not shown) integral with the shield 50.

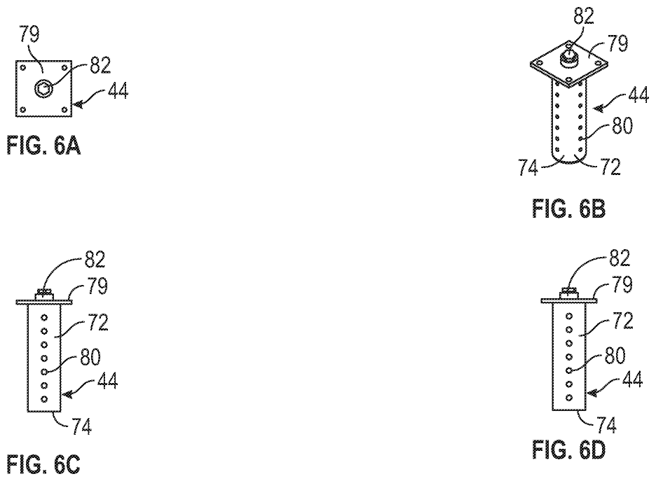

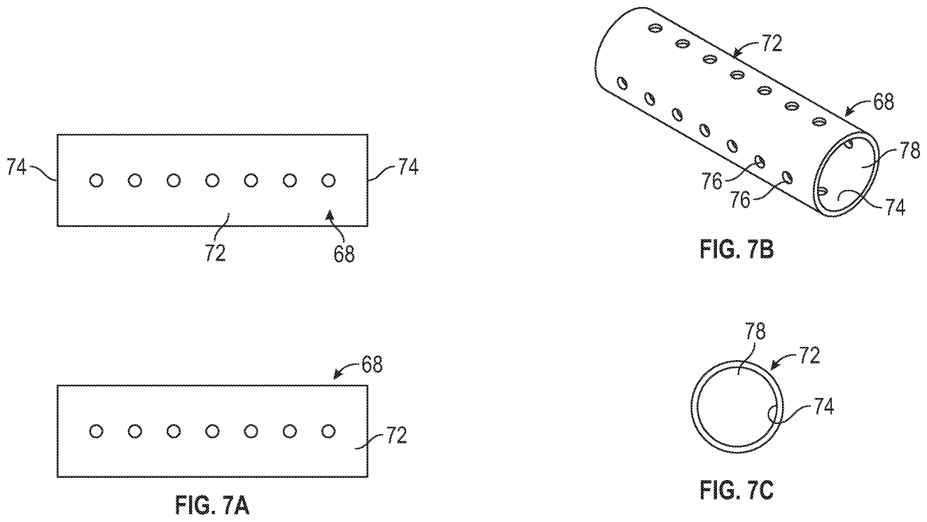

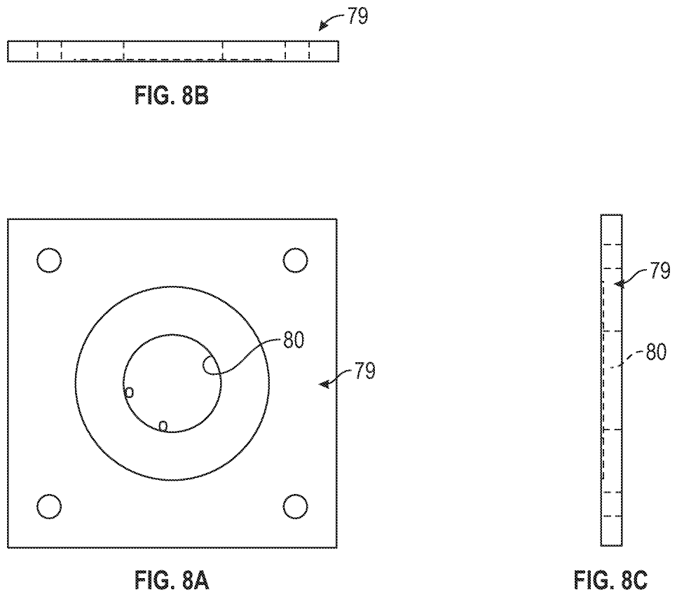

As shown in FIGS. 6A, 6B, and 6C, FIGS. 7A, 7B, and 7C, and FIGS. 8A, 8B, and 8C, the dry-bulb temperature sensor unit 44 includes a shield 68. In embodiments, the shield 68 is a cylindrical tube 72 with open ends 74 and a plurality of openings 76 along its length. In embodiments, the openings 76 are arranged in rectilinear rows along the length of the tube 72. In other embodiments, the openings 76 are arranged randomly or in other patterns, and there may be more or fewer than illustrated in the figures. In embodiments, the openings 76 are circular to eliminate arcing points, but may take different shapes. The openings 76 are sized to block microwave radiation from entering the interior 78 of the shield. In embodiments, the shield is made of stainless steel, but other corrosion-resistant conductive materials may be used.

Alternatively, the wet-bulb temperature sensor unit 42 includes a wet-bulb temperature sensor 62 in the form of a dew point sensor or a relative humidity sensor. The dew point sensor or relative humidity sensor 62 generates a signal indicative of dew point and/or relative humidity of the air within the microwave cooking enclosures 16 of the microwave cooking units 12A-12C. Each dew point and/or relative humidity sensor 62 is located within its respective microwave shield 50, and the misting nozzle 64 is eliminated.

In embodiments in which a dry-bulb temperature sensor unit 44 is used, each dry-bulb temperature sensor unit includes a top plate 79 that is attached to and covers an upper open end of the tube 72. The top plate 79 is attached to, or forms a part of, the top wall 18 of the housing 14 (see FIGS. 1 and 2). The top plate 79 includes an opening 80 that receives and supports a dry-bulb temperature probe or sensor 82, which in embodiments takes the form of a dry-bulb thermometer. Accordingly, in the system 10, the wet-bulb sensor can take the form of a wet-bulb thermometer 62, a combination wet-bulb thermometer and dry-bulb temperature sensor 82, a dew point temperature sensor, a relative humidity sensor, and combinations of the foregoing.

As shown in FIG. 2, in an embodiment, the system 10 includes moisture injection nozzles that take the form of steam nozzles 84, 86 in the housing 14 of each cooking unit 12A-12D. In embodiments, each cooking unit 12A-12D have more or fewer than two steam nozzles 84, 86 are positioned below the conveyor 24. In other embodiments, the steam nozzles 84, 86 are below and/or above the conveyors 24, 24A, and/or on one or both sides of the conveyors.

In an embodiment, the steam nozzles 84, 86 are supplied with saturated steam through a steam supply line 88. The flow of steam through the steam nozzles 84, 86 into the microwave cooking enclosures 16 is regulated by steam valves 90. The steam nozzles 84, 86 provide heat and moisture to the air in the microwave cooking enclosures 16 to form humidified air, in embodiments heated humidified air, within the cooking enclosures. In other embodiments, the nozzles 84, 86 take the form of mist nozzles that provide a fine mist of water droplets through a water line 88, the flow of which is regulated by water valves 90, to make humidified air within the microwave cooking enclosures 16.

In an embodiment, the system 10 includes a control 92, which may take the form of a programmable logic controller (PLC) or a microcontroller or microcontroller unit (MCU). In embodiments, the control 92 is connected to receive signals from the wet-bulb temperature sensor 62 and optionally the dry-bulb temperature sensor 82 from one or more of the cooking units 12A-12D. In an alternative embodiment, the control receives a signal from the dew point temperature sensor and/or relative humidity sensor 62 and a signal representative of temperature from the dry-bulb temperature sensor, and from that data calculates the wet-bulb temperature of the enclosure 16. For each cooking unit 12A-12D, the control 92 is also connected to control the valves 90 to regulate the flow of steam and/or heated water to the nozzles 84, 86 to regulate the humidity of the air in the microwave cooking enclosure 16. In an embodiment, the control 92 is programmed to modulate the flow of steam and/or water mist from the nozzles 84, 86 into the interior of the microwave cooking enclosure 16 as the microwave radiation is transmitted into the interior of the microwave cooking enclosure to tenderize the food products 100 on the conveyor 24, 24A as the food products are cooked and prevent dehydration of, and thus ensure lethality to microorganisms in the interior of the microwave cooking enclosure and on the outer surface of and within the food products in the interior of the microwave cooking enclosure.

In the embodiment of FIG. 1, in which the system 10 includes a plurality of the microwave cooking enclosures 16 of the cooking units 12A-12D, the conveyor 24, 24A conveys the food products 100 into and out of the interiors of successive ones of the plurality of the microwave cooking enclosures. The control 92 is programmed to modulate the valves 90 and/or the exhaust dampers 102 maintain the wet-bulb temperatures of the humidified air within the interiors of the plurality of the microwave cooking enclosures 16 at or above value selected to maintain lethality and provide even cooking of the food products 100 and to actuate the sources of microwave energy, which in embodiments are magnetrons 38, 40, to transmit the microwave radiation into the interiors of the microwave cooking enclosures, which, combined with the humidified air, cook the food products in the interiors of the microwave cooking enclosures and kill microorganisms therein and on the outer surfaces of and within the food products in the cooking enclosures. In this embodiment, the food products 100 are completely cooked by passing through the plurality of the microwave cooking enclosures 16 of cooking units 12A-12D.

In an exemplary embodiment, the microwave cooking enclosure 16 in each of the cooking units 12A-12D is approximately 133 ft³ for a conveyor 24 having 3 lanes, and in another embodiment the microwave cooking enclosure in each of the cooking units is approximately 164 ft³ for a conveyor having 4 lanes. With such embodiments, the control 92 actuates the valves 90 to deliver at least 200-225 lbs./hr. of steam to the microwave cooking enclosure 16, or about 2×10⁵ to 2.25×10⁵ btu/hr. (1.4×10⁴ to 1.58×10⁴ gm-cal./sec.). Thus, with this embodiment, steam, in embodiments saturated steam, is delivered to the microwave cooking enclosure 16 at a rate of between 1.37 and 1.50 lbs./hr.-ft³, or between 1370 and 1500 btu./hr.-ft³ (3440 to 3760 gm-cal./sec. ft³).

Optionally, the control 92 controls or actuates a control 94 that actuates the magnetrons 38, 40, actuates the valves for the misting nozzles 64, and/or the control 96 that starts, stops and modulates the speed of the conveyors 24, 24A. In embodiments, the control 92 may take the form of a standalone unit, which may be handheld or incorporated in a tablet, or may be integrated as a module or program into a larger control system (not shown). The control 92 may communicate with the aforementioned components by hardwire, over a network such as a control area network (CAN), and/or wirelessly. The control 92 in embodiments is physically adjacent the cooking units 12A-12D, and in other embodiments physically remote from the system 10 or offsite from the system.

In still other embodiments, the control 92 controls a secondary cooking device 98, which may take the form of a multiple purpose oven (MPO) and/or a forced convection oven, through which the conveyors 24, 24A pass to convey food products 100 before passing through the cooking units 12A-12D. Although FIG. 2 shows the secondary cooking device 98 positioned upstream of the system 10, in other embodiments, the secondary cooking device 98 is positioned downstream of the cooking units 12A-12D. In still other embodiments, secondary cooking device 98 takes the form of cooking devices positioned upstream and downstream of the system 10, and in other embodiments, one or more secondary cooking devices are placed between two or more of the cooking units 12A-12D, or combinations of one or more of the foregoing.

The process of operation of the system 10 is as follows. Food products 100 are placed into the interior of a microwave cooking enclosure 16 of a cooking unit 12. Microwave radiation from the source 38 of microwave energy is transmitted into the interior of the microwave cooking enclosure 16 to cook the food products 100. The control 92 actuates magnetrons 38, 40 of microwave cooking unit 12A, either simultaneously or sequentially as the conveyors 24, 24A transport food products 100 through the microwave cooking enclosure 16, to begin to cook the food products in the microwave cooking enclosure.

A signal is generated from a microwave-shielded sensor 62 positioned within the interior of the microwave cooking enclosure indicative of a wet-bulb temperature, and hence the relative humidity, of the humidified air within the interior of the microwave cooking enclosure 16. Alternatively, the control 92 is programmed to receive signals from the dew point temperature and/or relative humidity sensor 62, optionally from dry-bulb temperature sensor 82, and from that calculates the wet-bulb temperatures and relative humidity of the microwave cooking enclosure 16. A flow of steam to the interior of the microwave cooking enclosure 16 is provided through nozzles 84, 86; alternately, the nozzles provide a water mist. The control 92 opens valves 90 to actuate the nozzles 84, 86 to inject steam and/or water mist heat the air within the microwave cooking enclosures 16. The conveyors 24, 24A are actuated, in embodiments by the control 92, to convey food product 100, such as uncooked sliced bacon, that has been placed on the conveyors, in embodiments manually, through the entrance 26 and into microwave enclosure 16 of the first microwave cooking unit 12A.

The wet-bulb temperature, or in other embodiments the dew point temperature and/or the relative humidity, within the interior of the microwave cooking enclosure is maintained at or above a predetermined value by the control 92, which is programmed to receive the signal from the microwave-shielded sensor 62 indicative of the wet-bulb temperature, and hence the relative humidity of the humidified air, within the interior of the microwave cooking enclosure 16. In response, the control 92 is programmed to modulate the flow of steam and/or water mist into the interior of the microwave cooking enclosure 16. Simultaneously with maintaining the wet-bulb temperature and relative humidity at or above a predetermined value, the magnetrons 38 transmit microwave radiation into the interior of the microwave cooking enclosure 16 to cook the food products 100 in the interior of the microwave cooking enclosure. The combination of the microwave radiation and the heated humidified air from the added steam, microwave radiation, and/or water mist provide uniform cooking of the food products and prevent dehydration of microorganisms, thereby promoting killing microorganisms in the interior of the microwave cooking enclosure 16 and on the outer surface of and within the food products.

In embodiments, maintaining the wet-bulb temperature, and in other embodiments the dew point temperature and/or the relative humidity, within the interior of the microwave cooking enclosure 16 includes providing steam, in embodiments saturated steam, to the interior of the microwave cooking enclosure 16 through the steam nozzles 84, 86, which are modulated by the control 92, which is programmed to vary the flow rate of steam into the interior of the microwave cooking enclosure 16. In embodiments, maintaining the wet-bulb temperature within the interior of the microwave cooking enclosure 16 includes the control 92 being programmed to modulate the exhaust damper 102 connected to the interior of the microwave cooking enclosure to allow humidified air to exhaust from the interior of the microwave cooking chamber.

In embodiments, placing the food products 100 into the interior of the microwave cooking enclosure 16 includes placing the food products on the conveyor 24, and/or conveyor 24A to convey the food products into and out of the interior of the microwave cooking enclosure 16. In embodiments, wherein maintaining the wet-bulb temperature within the interior of the microwave cooking enclosure 16 includes actuating the valve 84 and/or 86 by the control 92 to maintain the wet bulb temperature within the interior of the microwave cooking enclosure between 158° F.-210° F. (70° C.-99° C.).

In embodiments, as shown in FIG. 1, food products 100 are placed successively into the interiors of the microwave cooking enclosures 16 of a plurality of the microwave cooking units 12A-12D as they are transported by conveyors 24 and optionally 24A into and out of each successive cooking unit 12A-12D. In each of the cooking units 12A-12D, the wet-bulb temperature within the interior of the microwave cooking enclosure 16 is modulated or maintained at or above the predetermined value by the control 92 in response to the signals received from the microwave-shielded sensor 62, and optionally 82, indicative of the wet-bulb temperature within the interior of the microwave cooking enclosure. The control 92 adjusts the valves 90 supplying steam and/or heated water to the nozzles 84, 86, and optionally by adjusting the exhaust dampers 102 to allow egress of steam and/or heated mist from the microwave cooking enclosures 16 in order to maintain the desired wet-bulb temperature in the interior of the microwave cooking chambers 16.

Simultaneously with maintaining the wet-bulb temperature, microwave radiation is transmitted into the interior of the microwave cooking enclosure 16 to cook the food products 100 in the interior of the microwave cooking enclosure. The microwave radiation and the steam heat kill microorganisms in the interior of the microwave cooking enclosure; and wherein the food products are completely cooked by at least one of the plurality of the cooking units. In one embodiment, the food products are completely cooked by a last one of the plurality of the cooking units. As used herein, the term ‘fully cooked’ and ‘completely cooked’ mean, for example, cooked to a degree to meet applicable food standards and/or kill microorganisms present on and/or in the food product.

For bacon slices, the valves 90 are adjusted to modulate the wet-bulb temperature within the enclosures 16 to at least 158° F., and preferably 176° F. or higher. In embodiments, the wet-bulb temperatures may vary from one microwave cooking enclosure 16 to another. The control 92 optionally controls exhaust dampers 102 in the top walls 18 of the housings 14 to modulate the flow of humid air, which in embodiments is steam-laden or moisture-laden air, from the enclosure 16, which lowers the wet-bulb temperatures in the microwave cooking enclosures 16. In an exemplary embodiment, this process is repeated as the food products 100 on the conveyor 24 pass through successive cooking units 12B, 12C, and 12D, so that the food products 100 are incrementally cooked, and a fully cooked food product 100 leaves exit 28 of the cooking unit 12D on conveyor 24. Alternatively, the food product is completely cooked in a single cooking unit 12. The resulting food product 100 is thoroughly cooked and active pathogen free yet is moist and provides pleasing organoleptic qualities. In other embodiments, additional cooking, such as browning, is effected by the secondary cooking device 98, which may occur before, during, or after microwave cooking by system 10.

Thus, the disclosed system 10 and process provide microwave cooking of food, such as bacon slices, in which the cooking is assisted by injection of steam, such as saturated steam, and/or a mist of heated water into the microwave cooking enclosure 16. Injection of steam and/or mist of heated water is modulated by a control 92 that continuously reads, or in embodiments calculates or derives, the wet-bulb temperature in the interior of the cooking enclosure 16 during the cooking process and continuously adjusts the valve 90, and optionally the exhaust damper 102 as part of a closed loop system, to control the flow of steam and/or moisture into the enclosure to modulate the wet-bulb temperature to maintain the wet-bulb temperature at or above a predetermined value. This value is selected to provide optimum cooking of the food product and maintain a humid atmosphere in the enclosure 16 that both provides hydrated surface lethality (HSL) of the food and sterilizes conveyors 24, 24A and components thereof, the walls of the microwave cooking enclosure 16, and other interior components of the cooking unit 12.

When the system 10 and process are used to cook bacon slices as the food products 100, the result is improved tenderization of bacon slices, consistent tenderization of bacon slices, more consistent product yields, assured destruction of pathogenic bacteria and other undesirable microorganisms on the food products and on the conveyer components, and assured destruction of spoilage bacteria on the food products and the conveyor components, in comparison to systems and processes that do not use steam to maintain a desired wet-bulb temperature.

In another embodiment, a closed loop system is not used to maintain the wet-bulb temperature within the microwave cooking enclosure 16 of one or more of the cooking units 12A-12D. Instead, the exhaust damper or exhaust dampers 102 of one or more of the cooking units 12A-12D are adjusted to control the humidified air exhausted from the interiors of the microwave cooking enclosures 16. In embodiments, this adjustment of wet-bulb temperature of the humidified air within the microwave cooking enclosure 16 takes the form of adjusting louvers of the dampers and/or the speed of the integral exhaust fans of the exhaust dampers to modulate the flow of humidified air from the interiors of the microwave cooking enclosures 16.

Propagation or distribution of the microwaves in the cooking chamber 16 without the presence of steam, and in embodiments a water mist, such as heated water mist, can cause the food product 100 to have a substantial temperature variation during microwave cooking. By microwave cooking the food product 100 in the presence of steam, the temperature of the food products and microwave propagation are more evenly distributed. In addition to maintaining uniform temperature and humidity levels within the microwave cooking enclosure 16, the steam heats the conveyors 24, 24A, which aids in the overall cooking process by providing direct contact cooking of the food products 100 in addition to cooking by microwave radiation and steam. By combining the benefits of cooking food products 100 in a humid atmosphere with simultaneous microwave cooking, increased food product throughput can be achieved, arcing from microwaves is minimized, increased lethality is achieved, and more even cooking effected.

While the forms of apparatus and processes described herein represent preferred embodiments of the disclosed process and system for microwave cooking with humidified air control, it is to be understood that the invention is not limited to these precise processes and systems, and that changes may be made therein without departing from the scope of the invention.

What is claimed is:

1. A system for microwave cooking food products with humidified air control, the system comprising:
a microwave cooking enclosure;
a source of microwave energy connected to transmit microwave radiation into an interior of the microwave cooking enclosure;
a microwave-shielded sensor positioned within the interior of the microwave cooking enclosure;
a steam nozzle connected to provide a flow of steam to the interior of the microwave cooking enclosure to make humidified air therein; and
a control connected to receive a signal from the microwave-shielded sensor indicative of a wet-bulb temperature within the interior of the microwave cooking enclosure and in response modulate the flow of steam into the interior of the microwave cooking enclosure to maintain the wet-bulb temperature therein at or above a predetermined value and to actuate the source of microwave energy to transmit the microwave radiation into the interior of the microwave cooking enclosure whereby the microwave radiation and the humidified air simultaneously cook the food products in the interior of the microwave cooking enclosure and kill microorganisms in the interior of the microwave cooking enclosure and on a surface of and within the food products.

2. The system of claim 1, wherein the control is programmed to cause steam to flow into the interior of the microwave cooking enclosure as the microwave radiation is transmitted into the interior of the microwave cooking enclosure to tenderize the food products as the food products are cooked and prevent dehydration of microorganisms in the interior of the microwave cooking enclosure.

3. The system of claim 1, further comprising a conveyor that conveys the food products into and out of the interior of the microwave cooking enclosure; and wherein the food products on the conveyor are simultaneously cooked and pasteurized by the microwave radiation and the steam within the microwave cooking enclosure.

4. The system of claim 3, wherein the microwave radiation and the steam kill the microorganisms on and within the food products and on the conveyor within the interior of the microwave cooking enclosure.

5. The system of claim 3, further comprising a plurality of the microwave cooking enclosures; and the conveyor conveys the food products into and out of the interiors of successive ones of the plurality of the microwave cooking enclosures; and wherein the control is programmed to maintain the wet-bulb temperatures within the interiors of the plurality of the microwave cooking enclosures at or above the predetermined value and to actuate the sources of microwave energy to transmit the microwave radiation into the interiors of the microwave cooking enclosures to cook the food products in the interiors of the microwave cooking enclosures and kill microorganisms in the interiors of the microwave cooking enclosures and on the surface of and within the food products; whereby the food products are completely cooked by the plurality of the microwave cooking enclosures.

6. The system of claim 1, wherein microwave-shielded sensor is selected from a wet-bulb thermometer, a combination wet-bulb thermometer and dry-bulb thermometer, dew point temperature sensor, a relative humidity sensor, and combinations of the foregoing.

7. The system of claim 1, further comprising a valve connected to regulate a rate of flow of steam into the microwave cooking enclosure from the steam nozzle.

8. The system of claim 7, wherein the control is programmed to actuate the valve to maintain the wet-bulb temperature within the interior of the microwave cooking enclosure at or above the predetermined value in a closed-loop system with the microwave-shielded sensor.

9. The system of claim 8, wherein the control is programmed to actuate the valve to maintain the wet bulb temperature within the interior of the microwave cooking enclosure selected from between 158° F.-210° F. (70° C.-99° C.), between 176° F.-194° F. (80° C.-90° C.), and if the food products are bacon slices, between 176° F.-210° F. (80° C.-99° C.).

10. The system of claim 1 further comprising a secondary cooking device selected from a multiple purpose oven (MPO) and/or a forced convection oven.

11. The system of claim 1, further comprising an exhaust damper connected to the interior of the microwave cooking enclosure to allow the humidified air to be exhausted from the interior of the microwave cooking chamber.

12. The system of claim 11, wherein the control is programmed to selectively modulate the exhaust damper to control a rate of the humidified air flow exhausted from the interior of the microwave cooking enclosure to the ambient to maintain the wet-bulb temperature within the interior of the microwave cooking enclosure at or above the predetermined value in a closed-loop system with the microwave-shielded sensor.

13. A system for microwave cooking food products with humidified air control, the system comprising:
a microwave cooking unit, the microwave cooking unit including
a microwave cooking enclosure,
a source of microwave energy connected to transmit microwave radiation into an interior of the microwave cooking enclosure,
a microwave-shielded sensor positioned within the interior of the microwave cooking enclosure that detects one or more of wet-bulb temperature, dew point temperature, and relative humidity within the microwave cooking enclosure,
a steam nozzle connected to provide a flow of steam to the interior of the microwave cooking enclosure to make humidified air therein, and
an exhaust damper connected to the interior of the microwave cooking enclosure to exhaust the humidified air from the interior of the microwave cooking chamber;
a conveyor that conveys food products into and out of the interior of the microwave cooking enclosure; and
a control connected to receive a signal from the microwave-shielded sensor indicative of the one of the wet-bulb temperature, the dew point temperature, and the relative humidity within the interior of the microwave cooking enclosure and in response modulate the flow of steam into the interior of the microwave cooking enclosure and/or modulate the exhaust damper to maintain the wet-bulb temperature within the interior of the microwave cooking chamber at or above a predetermined value and simultaneously actuate the source of microwave energy to transmit the microwave radiation into the interior of the microwave cooking enclosure, whereby the microwave radiation and the humidified air simultaneously cook the food products on the conveyor in the interior of the microwave cooking enclosure and kill microorganisms on an outer surface of and within the food products, on the conveyor in the interior of the microwave cooking enclosure, and on the interior of the microwave cooking enclosure.

14. The system of claim 13, further comprising a valve connected to regulate a rate of flow of steam into the microwave cooking enclosure from the nozzle, wherein the control is programmed to actuate the valve and/or modulate the exhaust damper to maintain the wet-bulb temperature within the interior of the microwave cooking enclosure at or above the predetermined value in a closed-loop system with the shielded sensor.

15. A process for microwave cooking food products with humidified air control, the process comprising:
placing food products into an interior of a microwave cooking enclosure of a cooking unit;
transmitting microwave radiation from a source of microwave energy into the interior of the microwave cooking enclosure to cook the food item;
generating a signal from a microwave-shielded sensor positioned within the interior of the microwave cooking enclosure indicative of a wet bulb temperature within the interior of the microwave cooking enclosure;
providing a flow of steam to the interior of the microwave cooking enclosure to form humidified air therein;
maintaining the wet-bulb temperature of the humidified air within the interior of the microwave cooking enclosure at or above a predetermined value by a control receiving a signal from the microwave-shielded sensor indicative of the wet-bulb temperature within the interior of the microwave cooking enclosure and in response modulating the flow of steam into the interior of the microwave cooking enclosure; and
simultaneously with maintaining the wet-bulb temperature, transmitting the microwave radiation into the interior of the microwave cooking enclosure to cook the food products in the interior of the microwave cooking enclosure, the microwave radiation and the humidified air combining to kill microorganisms in the interior of the microwave cooking enclosure and on an outer surface of and within the food products therein.

16. The process of claim 15, wherein maintaining the wet-bulb temperature within the interior of the microwave cooking enclosure includes providing steam to the interior of the microwave cooking enclosure through a steam nozzle modulated by the control.

17. The process of claim 15, wherein maintaining the wet-bulb temperature within the interior of the microwave cooking enclosure includes modulating an exhaust damper connected to the interior of the microwave cooking enclosure by the control to allow air and/or steam to escape from the interior of the microwave cooking chamber.

18. The process of claim 15, wherein placing the food products into the interior of the microwave cooking enclosure includes placing the food products on a conveyor that conveys the food products into and out of the interior of the microwave cooking enclosure.

19. The process of claim 15, wherein maintaining the wet-bulb temperature within the interior of the microwave cooking enclosure includes actuating the valve by the control to maintain the wet bulb temperature within the interior of the microwave cooking enclosure between 158° F.-210° F. (70° C.-99° C.).

20. The process of claim 15, further comprising placing food products successively into the interiors of the microwave cooking enclosures of a plurality of the cooking units; and in each of the cooking units, maintaining the wet-bulb temperature within the interior of the microwave cooking enclosure at or above the predetermined value by the control receiving the signals from the microwave-shielded sensor indicative of the wet-bulb temperature within the interior of the microwave cooking enclosure and in response modulating the flow of steam into the interior of the microwave cooking enclosure; and simultaneously with maintaining the wet-bulb temperature, transmitting the microwave radiation into the interior of the microwave cooking enclosure to cook the food products in the interior of the microwave cooking enclosure, the microwave radiation and the steam killing microorganisms in the interior of the microwave cooking enclosure; and wherein the food products are completely cooked by at least one of the plurality of the cooking units.

21. A process for microwave cooking food products with humidified air control, the process comprising:
placing food products into an interior of a microwave cooking enclosure of a cooking unit;
transmitting microwave radiation from a source of microwave energy into the interior of the microwave cooking enclosure to cook the food products;
providing a flow of steam and/or water spray to the interior of the microwave cooking enclosure to form humidified air therein;
maintaining a wet-bulb temperature of the humidified air within the interior of the microwave cooking enclosure at or above a predetermined value; and
simultaneously with maintaining the wet-bulb temperature, transmitting the microwave radiation into the interior of the microwave cooking enclosure to cook the food products in the interior of the microwave cooking enclosure, the microwave radiation and the humidified air combining to cook the food products in the interior of the microwave enclosure and kill microorganisms in the interior of the microwave cooking enclosure and on an outer surface of and within the food products therein.
